(19) United States
(12) Patent Application Publication
(10) Pub. No.: US 2013/0278064 A1
(43) Pub. Date: Oct. 24, 2013

(54) Ultra-Low Noise, High Voltage, Adjustable DC-DC Converter Using Photoelectric Effect

(71) Applicant: Marcos de Azambuja Turqueti, Vista, CA (US)

(72) Inventor: Marcos de Azambuja Turqueti, Vista, CA (US)

(73) Assignee: CREATIVE ELECTRON, INC., San Marcos, CA (US)

(21) Appl. No.: 13/656,504

(22) Filed: Oct. 19, 2012

Related U.S. Application Data
(60) Provisional application No. 61/549,165, filed on Oct. 19, 2011.

(51) Int. Cl. G05F 3/08

(52) U.S. Cl. CPC G05F 3/08
USPC 307/43; 29/825

(57) ABSTRACT

A DC-DC step-up converter is described that uses opto-electric conversion to supply very low noise/ultra-low noise, high voltages using branch(es) of optical detectors. The optical detectors are series connected to form a large branch of photon-to-electron converters. The input voltage can be low, with the output voltage shown to be highly stable, low current (parallel branches can increase the output current), controllable and virtually free of any jitter. The described approach is very reliable and inexpensive.

### CROSS-REFERENCE TO RELATED APPLICATIONS

This application claims the benefit of U.S. Provisional Patent Application No. 61/549,165, titled “Ultra-Low Noise, High Voltage, Adjustable DC-DC Convertor Using Photoelectric Effect,” filed Oct. 19, 2011, the contents of which are hereby incorporated by reference in its entirety.

### FIELD

This invention relates to the generation of a very low noise, DC supply using staged optical detectors.

### BACKGROUND

Power supplies that require a high voltage output invariably require a step-up transformer, which requires an input AC source to properly step-up the input current/voltage. If the input source is a DC source, then a chopping circuit is required to create the AC for input into the step-up transformer. If DC output is desired, after step-up, the AC component must be filtered out to bring the output signal back to DC. However, filtering AC to DC is not a simple procedure, practically being a specialized field of electrical engineering in of itself. Therefore, all DC-DC systems require significant filtering resources to reduce the effects of the introduced noise. Ideally, a DC-DC conversion without noise introduction would be desired. Yet, over the last hundred or more years of science in the field of DC-DC converters systems, no known approach has been found that does not require a chopper or similar device, particularly for step-up, high voltage systems.

In view of the above, there has been a long standing need in the electrical engineering community for methods and systems for a “simple” DC-DC converter with ultra-low noise characteristics. Ultra-low noise is a term of art indicating that there is little fluctuation of the output voltage. Some commercial examples of ultra-low noise DC-DC converters tout a fluctuation of less than 10 mV over an output range of 4-25 V. Depending on the output voltage, the fluctuation may vary as a percentage thereof, usually designated as less than 1 percent or even less than 0.5 percent. Using this metric as a benchmark, methods and systems are described for a DC-DC converter system that provides ultra-low noise characteristics, and a high (as well as low) voltage potential using an optical conversion approach.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

One aspect of the present disclosure, an ultra-low noise, DC-DC converter is described, comprising: a DC low voltage source; a light source powered by the power source; a plurality of photon-to-electron converting devices, serially connected, in a light path of the light source; and an output terminal connected a top node of a first of the plurality of photon-to-electron converting devices and connected to a bottom node of a last of the plurality of photon-to-electron converting devices, wherein the output voltage is DC, ultra-low noise and approximately a multiple of a number of the plurality of photon-to-electron converting devices and a voltage drop across each photon-to-electron converting device.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings. As such, other aspects of the disclosure are found throughout the specification.

### BRIEF DESCRIPTION OF THE DRAWINGS

FIG. 1 a very simple schematic of a prior art DC-DC converter.

FIG. 2 is a circuit illustration of an exemplary DC-DC converter.

FIG. 3 is an illustration of an exemplary DC-DC converter using a light-to-voltage configuration.

FIGS. 4A-C are illustrations of other exemplary DC-DC converters using light-to-voltage configurations.

FIG. 5 is an illustration of another exemplary DC-DC converter using a light-to-voltage configuration.

FIG. 6 is an illustration of another exemplary DC-DC converter using a light-to-voltage configuration.

FIGS. 7A-B are illustrations of exemplary DC-DC converters using planar/semiconductor light-to-voltage configurations.

FIGS. 8A-B are illustrations of an arrangement of an exemplary DC-DC converter using a light-to-voltage configuration.

FIGS. 9A-C are illustrations of a planar-arranged exemplary DC-DC converter.

### DETAILED DESCRIPTION

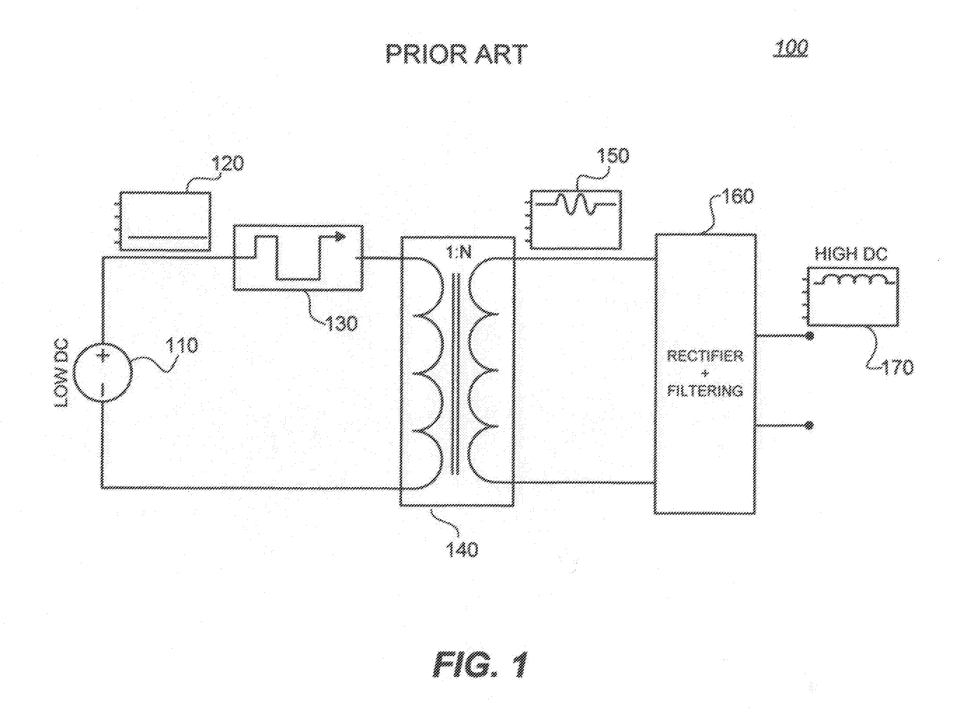

FIG. 1 is a schematic of a prior art DC-DC step-up converter 100, using a low voltage DC power supply 110 with output “voltage” illustrated in image 120. The output voltage is fed to a chopping circuit 130 which generates an alternating current/voltage which is fed into the step-up transformer 140 having a 1:N ratio of turns or step-up value. The high voltage and time harmonic output of the transformer 140 is illustrated in image 150. Due to the fact that the output voltage is alternating, a rectifying circuit/filtering circuit 160 is used to remove the sinusoidal components. The resulting high voltage DC is show in image 170. Various levels of filtering can be used in the prior art to further “clean up” the output signal so that it is more akin to a flat line voltage than one with ripples. But, as mentioned in the Background, the filtering/removing of ripples, harmonics, spurious signals from the output of the transformer 140 is not a trivial task. The end result of this step-up procedure is that nearly all prior art systems have some degree of “ripple” in the output signal. Moreover, nearly all prior systems require a transformer, which cannot be manufactured at a “chip-level.” Further, transformers have hysteresis effects and are prone to heat up, causing large power losses as well as the potential for the transformer wiring to fail/melt under heavy load.

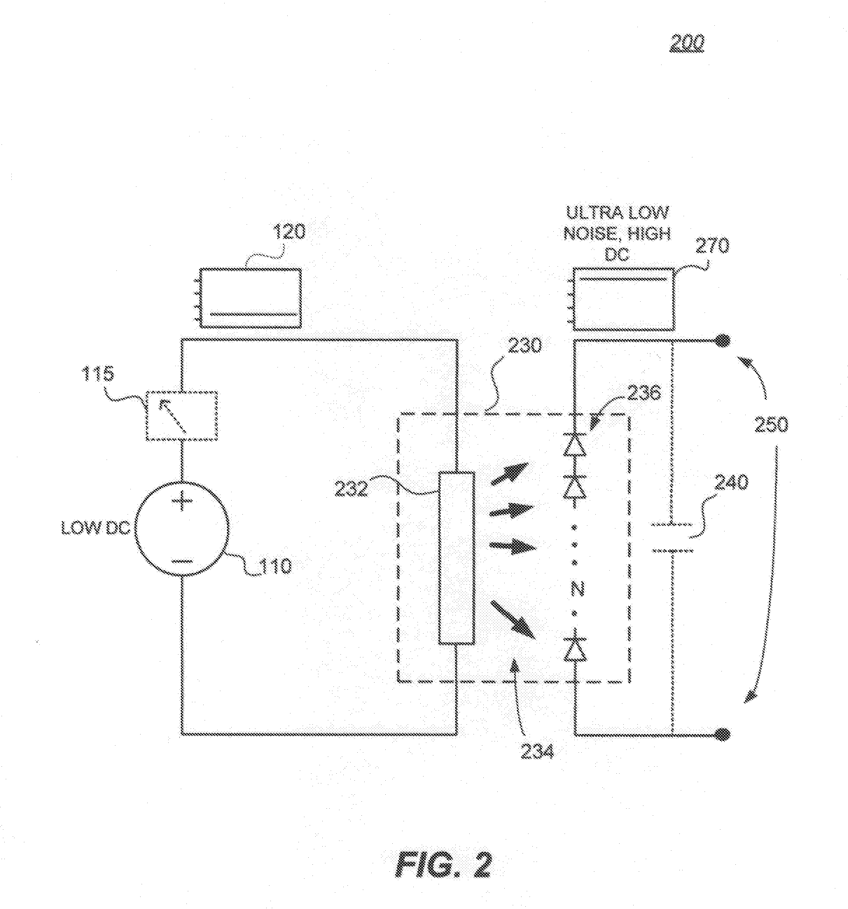

FIG. 2 is a circuit illustration 200 of an exemplary DC-DC converter using the photoelectric effect to convert optical energy into a stable/low noise high voltage source. Specifically, low voltage source 110 provides a low voltage (shown in image 120) to exemplary DC-DC converter 230.

Before proceeding, it is understood in the semiconductor/portable consumer electronics community, the term low voltage is typically held to be below 10 volts, and sometimes just a few volts or less, being within the typical ranges used for semiconductor devices. Of course, as will be evident to one of ordinary skill, the term low voltage is relative to the context of the device it is being applied to. Therefore, while less than 10 volts may be a value used to describe low voltage, it is understood that the low voltage sources for the exemplary embodiments herein are not limited to voltages less than 10 volts.

Returning to FIG. 2, prior to feeding to exemplary DC-DC converter 230, the system may optionally include a potentiometer or other means to regulate/control the amplitude of low voltage source 110.

Exemplary DC-DC converter 230 comprises a light source 232 that emits photons 230 to a bank of optical-to-voltage receivers 236. In this embodiment, the optical-to-voltage receivers 236 are shown as photodiodes, but may be any device capable of converting photonic energy to electrical energy. Photodiodes are used in various embodiments, simply because they are relatively inexpensive and provide a very regulated, consistent conversion of light energy to voltage/current energy. However, as mentioned above, other photon-to-electron converting devices may be used.

Light, of sufficient energy, striking each photodiode 236 will impress a voltage across each photodiode 236 (essentially, turning it “on”). The series staging of N number of photodiodes 236 will cascade each photodiodes' voltage to N×voltage, resulting in a high voltage (seen in image 270) at output terminals 250. Optional capacitor 140 is provided to help maintain a consistent voltage or for charge build up.

No ripples or spurious signals are injected in to the input low DC voltage. The output terminal voltage is easily regulated by turning on or off light source 232. Photodiodes 236 (usually being of semiconductor construction) are understood in the art to be very reliable. The resulting exemplary DC-DC converter circuit avoids the use of a step-up transformer, thus avoiding the problems usually found when using magnetic circuits. Additionally, the use of an opto-electric conversion isolates the output voltage from the input source and from other electronics that may be in the circuit, further providing a very clean output voltage.

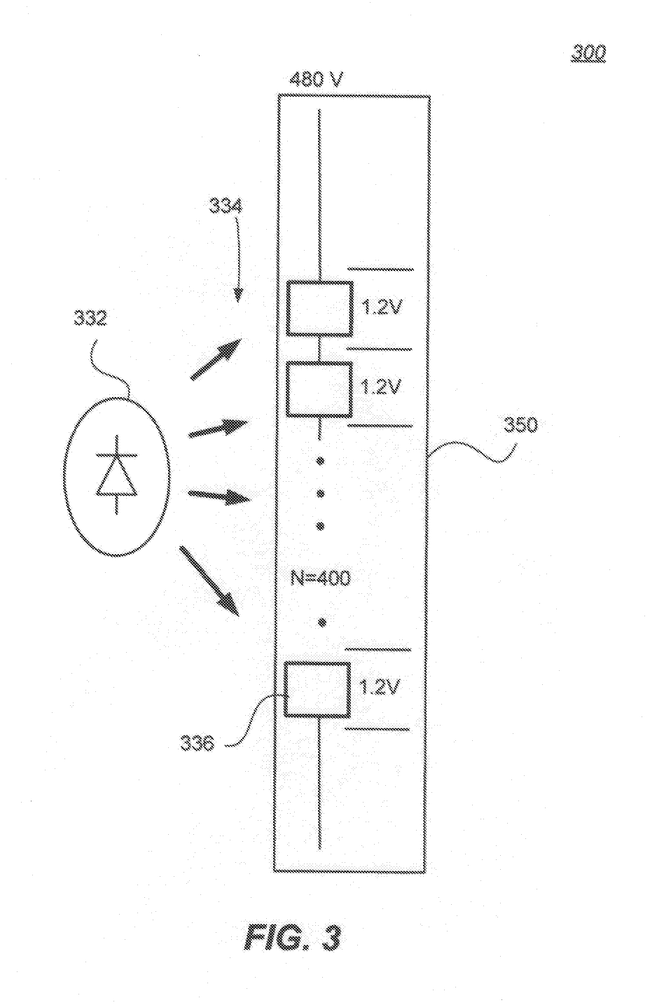

FIG. 3 is an illustration of an exemplary DC-DC converter 300 using a light-to-voltage configuration, wherein the light source is a photodiode 232 but used as an LED, sending photon 334 to a bank 350 of 400 photon-to-electron devices 336. In this scenario, the voltage drop across each photon-to-electron devices 336 is shown as 1.2 Volts. Consequently, a total voltage drop of 480 Volts can be obtained with this very elegant and simple arrangement.

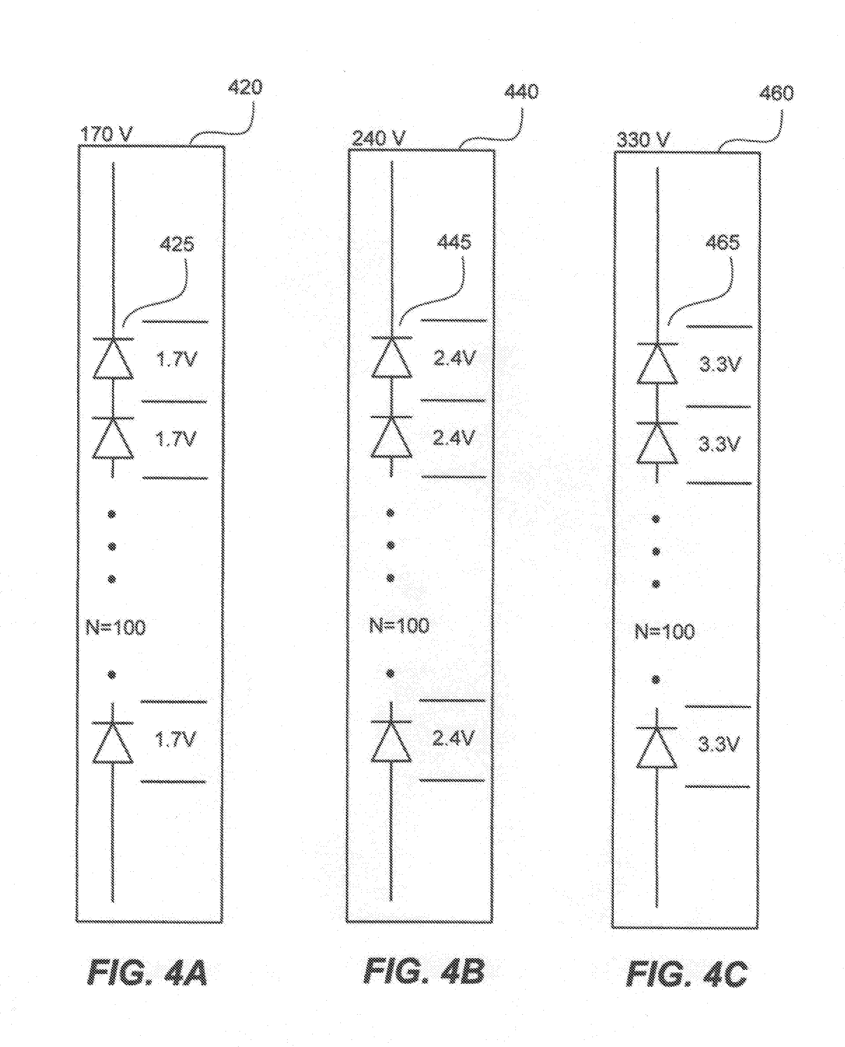

FIGS. 4A-C are illustrations of other exemplary DC-DC converters using light-to-voltage configurations that are variations of the bank 350 seen in FIG. 3. In particular, FIG. 4A illustrates each photon-to-electron device (shown, for example, as a photodiode) 425 having a voltage drop of 1.7 V. Presuming the number of devices 425 to be 100. The total voltage can be 170 V. FIG. 4B's bank 440 is comprised of devices 445 that have a voltage drop of 2.4 V, resulting in a total voltage drop of 240 V. FIG. 4C's bank 460 is comprised of devices 465 that have a voltage drop of 3.3V, resulting in a total voltage drop of 330 V. It is worthy to note that the three scenarios shown correspond to the typical voltage drops found for a Red, Green, and Blue photodiode, respectively.

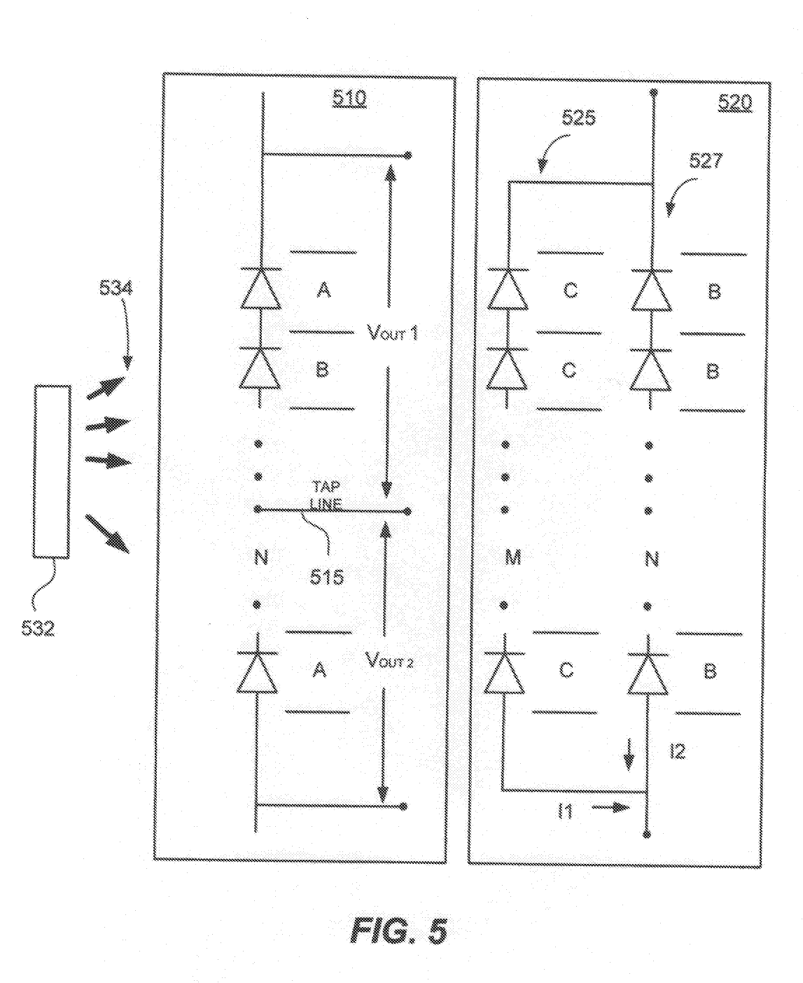

FIG. 5 is an illustration of another exemplary DC-DC converter different light-to-voltage arrangements. Light source 532 sends photons 534 to bank 510 that has a series of photon-to-electron devices (shown, for example, as photodiodes) of varying turn-on voltage/output voltage (A, B, etc.) with a tap line 515. The tap line allows for the output voltage to be “tapped” at a different point on the bank, thus providing a Vout 1 and Vout 2 as well as Vout 1+Vout 2 voltages. In combination with the different turn-on voltage/output voltages and taps, varying voltages may be output. It should be noted that while only one tap is shown, more than one tap may be utilized.

FIG. 5B illustrates a bank 520 with a parallel branches 525 and 527. Branch 525 is composed of photon-to-electron devices (shown, for example, as photodiodes) having turn-on voltage/output voltage of C volts, while Branch 527 is composed of photon-to-electron devices (shown, for example, as photodiodes) having turn-on voltage/output voltage of B volts. In combination with the different number (M versus N) devices in each branch, different current values may be output from a single bank 520.

In one scenario, the devices in branch 525 may have a very high turn-on/output voltage, (C), so that if light source 532's photons 534 have an energy value that is below C, then that branch will not turn on and I1 will be zero. Conversely, if devices in branch 527 may have a low high turn-on/output voltage, (B), so that if light source 532's photons 534 have an energy value that is above B, then that branch will turn on and I2 will not be zero. Depending on what level of light/energy from light source 532, different branches may be turned on or off. Moreover, with a parallel circuit setup, and if light source 532 is sufficiently energetic for both branches 525 and 527, then if one element/diode in a branch fails, voltage from the other branch will still be available. That is, a parallel circuit can be designed for redundancy, as is well known in the art. Therefore, in a redundant scenario, C may equal to B, or the values of M and/or C (or N and/or B) are managed to where M×C=N×B.

It is apparent that given the above, various modifications and changes may be made to the arrangement, values, configuration and so forth, without departing from the spirit and scope therein.

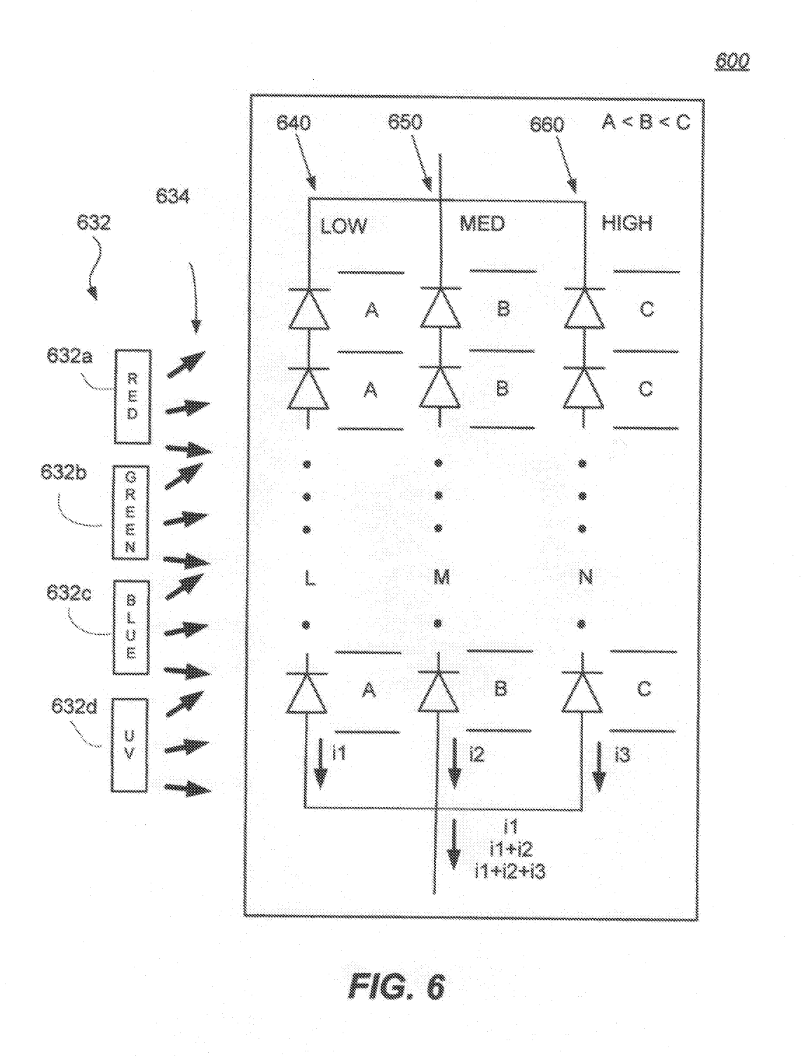

FIG. 6 is an illustration of another exemplary DC-DC converter 600 using a light-to-voltage configuration having multiple light sources 632 of different frequencies, 632a, 632b, 632c, and 632d. Photons 634 impinge upon multiple branches 640, 650, 660, each having different voltage turn-on/output voltages. The respective values A, B, C are, for demonstration purposes, shown as being A<B<C. Presuming A will only turn on for a Red frequency, then branch 640 will turn when the light source is Red 632a. Presuming B will only turn on for a Green frequency, then branch 650 will turn when the light source is Green 632b. Presuming C will only turn on for a Blue frequency, then branch 660 will turn when the light source is Blue 632c. It should be apparent that if A<B<C, then branch 640 will also turn on for a Green light source 632b, and branch 650 and branch 640 will also turn on for a Blue light source 632c.

If light source 632 is UV, then all branches 640, 650, and 660 will turn on. Accordingly, from this configuration, higher currents than typically possible can be obtained by combining different turned-on branches.

By using the L×A=M×B=N=C arrangement alluded to in FIG. 6, the output voltage can be held at a constant value. Of course, it may be desirable to avoid this equivalence, if the voltage is not desired to be constant.

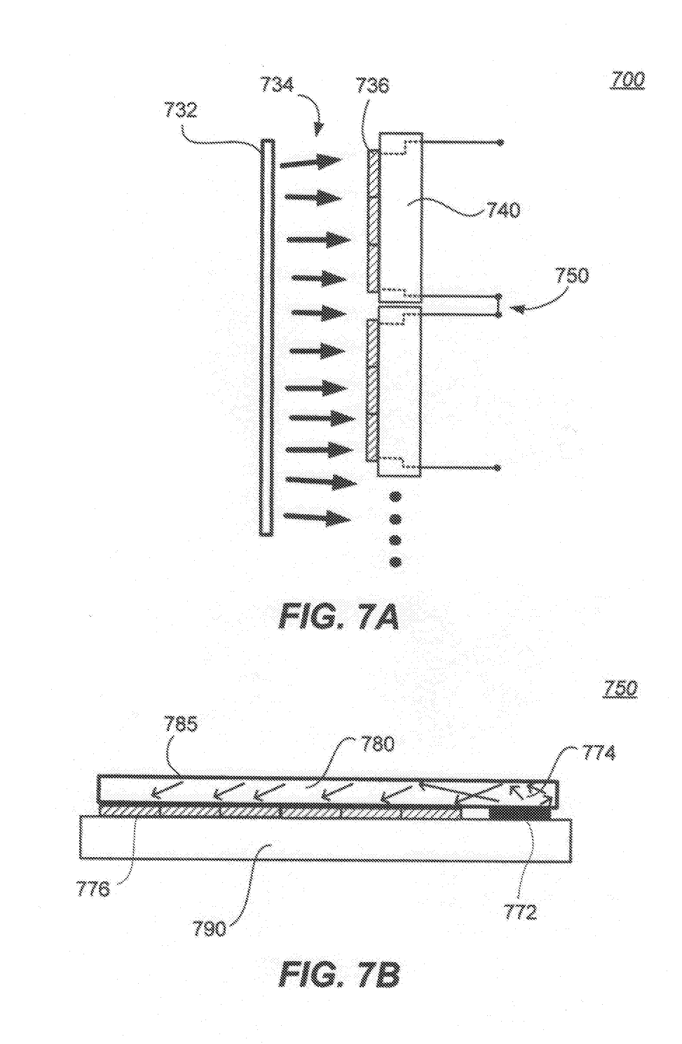

FIGS. 7A-B are illustrations of exemplary DC-DC converters using planar/semiconductor light-to-voltage configurations. FIG. 7A illustrates a system 700 wherein a ribbon light source 732 emits photon 734 towards a layer of photon-to-electron converter 736 that are disposed on individual substrates 740. Serial connection 750 of each substrate 740 builds a bank of exemplary DC-DC converters. This embodiment demonstrates the use of “non-discrete” photon-to-electron converter 736, that is a semiconductor based configuration.

FIG. 7B is an illustration of a compact end-fire configuration where light source 772 is disposed on a substrate 790. Light 774 is emitted into a light tube or light channel 780 that reflects and directs entered light down the length of the light channel 780 to be emitted to photon-to-electron converters 776 that are laterally disposed on the substrate 790 next to the light source 772. The light channel 780 may have a mirrored top face 785 or other mechanism for directing light 774 to the photon-to-electron converters 776. The light channel may have a different index of refraction at its faces to facilitate the channeling and transmission effects. Additionally, the lower face of the light channel 780 may have a grating to diffuse light 774 out of the channel 780 to the photon-to-electron converters 776.

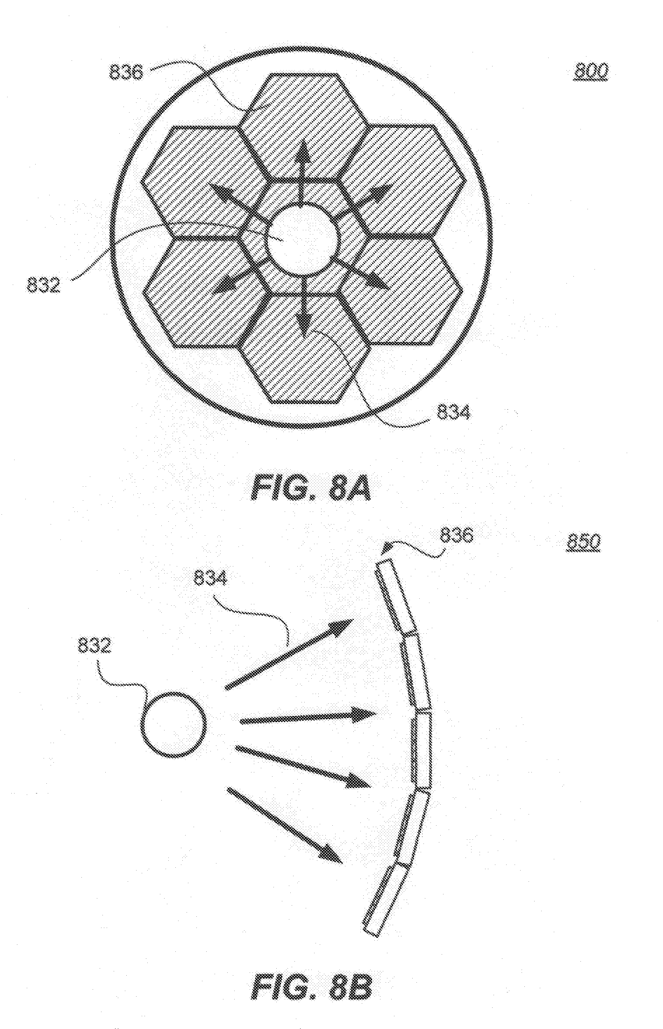

FIGS. 8A-B are illustrations of an arrangement of an exemplary DC-DC converter using a curved light-to-voltage configuration. FIG. 8A illustrates an arrangement 800 of “plates” of semiconductor-based of photon-to-electron converters 836, situated to be substantially perpendicular to light 834 emanating from light source 832. Here, light source 832 is imagined to be a spherical light source, radiating light in radial directions, therefore to maximize energy coupling, a perpendicular arrangement of the photon-to-electron converters 836 is envisioned.

FIG. 8B is a side view 850 of the arrangement 800 of FIG. 8A and is understood to be self-explanatory. To increase light intensity towards the photon-to-electron converters 836, a mirror or reflecting body (not shown) may be placed on the back-side of the light source 832. Due to the fact that light energy will attenuate as a function of distance, for increased efficiency, the distance between the light source 832 and the photon-to-electron converters 836 should be minimized.

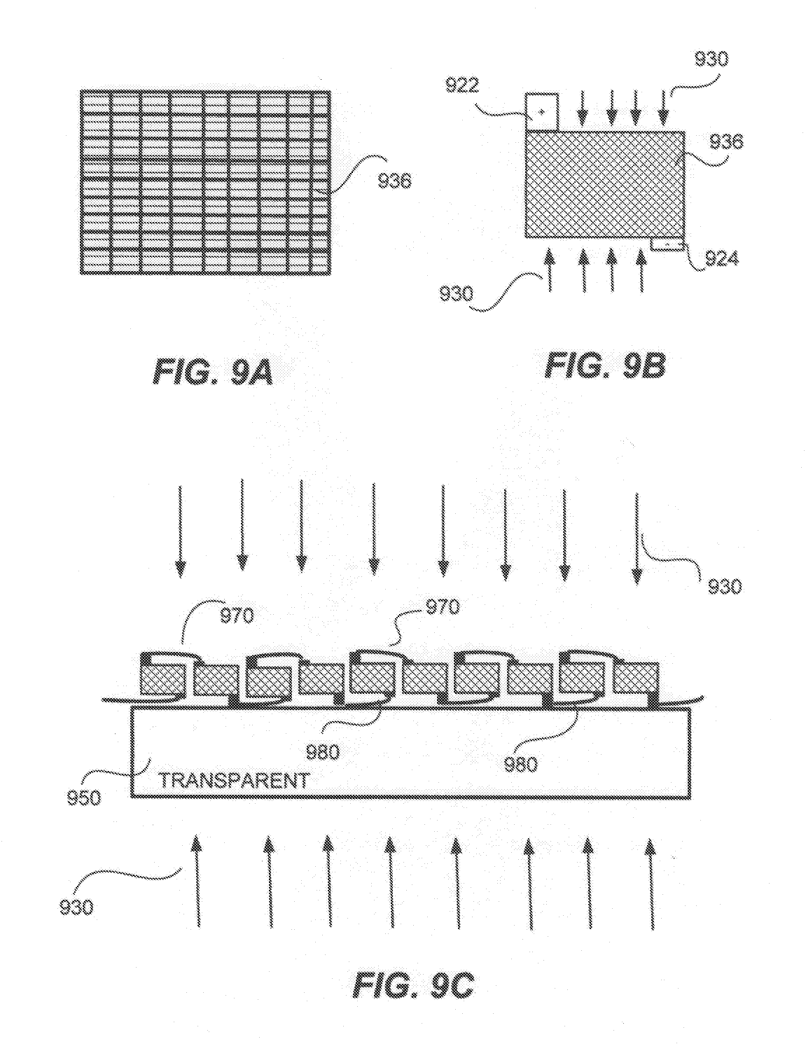

FIGS. 9A-C are illustrations of a planar-arranged exemplary DC-DC converter. In view of FIG. 8's curved embodiment, a planar embodiment is shown in FIG. 9A where photon-to-electron converters (e.g., photodiode) 936 are arranged as a planar array, with substantially rectangular rows of converters 936. FIG. 9B is a side view of a single semiconductor/chip photodiode 936, typically showing the two terminal, 922 (referred to here as “+”) and 924 (referred to here as “−”), whereas the photodiode 936 is sensitive to light in both its top and bottom directions (indicated by light 930 from both sides). The terminal arrangement of this type of photodiode 936 is problematic as it makes series connections to be awkward, when laid side-by-side on a substrate.

However, as shown in FIG. 9C, if the photodiodes 936 are laid in alternating reversed order, then the + terminal will be adjacent to the − terminal, which can be connected at the “top” side by leads 970 and connected on the bottom side by leads 980. The photodiodes 936 can then be bonded to a transparent substrate 950, thus allowing light 930 arriving from both top and bottom directions to impinge upon both sides of the photodiodes 936.

It should be understood that while the above exemplary embodiments describe systems and methods that are directed to a “step-up” DC-DC converter system (e.g., High or Higher Voltage output), the same described principles may be applied to provide a “step-down” DC-DC converter system (Low or Lower Voltage output). For example, instead of using a large number of receiving photodiodes, only a few photodiodes can be used, thus drastically reducing the output voltage. Additionally, while it is understood that the exemplary embodiments can provide higher voltages, but not higher currents, various amounts of current can be generated using the branching systems described. Therefore, the exemplary systems may rise to “high-power,” depending on design implementation.

Irrespective of which mode is devised, benefits of the exemplary embodiments are that they are extremely low noise, very stable, long lasting, and relatively inexpensive, as compared to other DC-DC converters.

In view of the above description, it will be understood that many additional changes in the details, materials, steps and arrangement of parts, may be made by those skilled in the art within the principle and scope of the invention as expressed in the appended claims.

What is claimed is:

1. An ultra-low noise, DC-DC converter, comprising:
a DC low voltage source;
a light source powered by the power source;
a plurality of photon-to-electron converting devices, serially connected, in a light path of the light source; and
an output terminal connected a top node of a first of the plurality of photon-to-electron converting devices and connected to a bottom node of a last of the plurality of photon-to-electron converting devices,
wherein the output voltage is DC, ultra-low noise and approximately a multiple of a number of the plurality of photon-to-electron converting devices and a voltage drop across each photon-to-electron converting device.

2. The converter of claim 1, further comprising a capacitor across the output terminal.

3. The converter of claim 1, further comprising, another plurality of photon-to-electron converting devices, serially connected, also in a light path of the light source and in a parallel connection to the output terminal.

4. The converter of claim 1, wherein the light source is an LED and is at least one of a red, green, blue, and UV color.

5. The converter of claim 1, wherein the number of the plurality of photon-to-electron converting devices is greater than 50.

6. The converter of claim 1, wherein the plurality of photon-to-electron converting devices are photodiodes.

7. The converter of claim 1, wherein the plurality of photon-to-electron converting devices are planar and disposed on a semiconductor substrate.

8. The converter of claim 7, further comprising a light channel receiving light from the light source and channeling it to the photon-to-electron converting devices.

9. The converter of claim 1, wherein the plurality of photon-to-electron converting devices are arranged in a semi-circular pattern, substantially equidistant in a radial direction from the light source.

10. The converter of claim 1, wherein the plurality of photon-to-electron converting devices are arranged in a matrix, wherein a positive terminal and a negative terminal are on opposite sides of a photon-to-electron converting device of the plurality of photon-to-electron converting devices.

11. The converter of claim 10, wherein the matrix of the plurality of photon-to-electron converting devices are serially adjacent to each other, with a positive terminal of a one photon-to-electron converting device is connected to a negative terminal of an adjacent photon-to-electron converting device.

12. The converter of claim 11, wherein the matrix of the plurality of photon-to-electron converting devices are disposed over a transparent substrate, wherein light can strike a side of the plurality of the photon-to-electron converting devices adjacent to the transparent substrate and strike a side distal to the transparent substrate.

13. The converter of claim 1, wherein the light source is an array of LEDs.

14. A method for generating a ultra-low noise, DC-DC voltage from a light source, comprising:
powering a light source via a DC low voltage source;
connecting a plurality of photon-to-electron converting devices in a serial fashion in a light path of the light source; and
connecting an output terminal to a top node of a first of the plurality of photon-to-electron converting devices and to a bottom node of a last of the plurality of photon-to-electron converting devices,
wherein the output voltage is DC, ultra-low noise and approximately a multiple of a number of the plurality of photon-to-electron converting devices and a voltage drop across each photon-to-electron converting device.

15. The method of claim 14, wherein the light source is an LED and is at least one of a red, green, blue, and UV color, an individual light source's LED having a given color being turned on or off to provide a different output voltage.

16. The method of claim 14, further comprising, serially connecting another plurality of photon-to-electron converting devices, also in a light path of the light source and in a parallel connection to the output terminal.

17. The method of claim 14, further comprising disposing a matrix of the plurality of photon-to-electron converting devices over a transparent substrate, wherein light can strike a side of the plurality of the photon-to-electron converting devices adjacent to the transparent substrate and strike a side distal to the transparent substrate.
